(19) United States
(12) Patent Application Publication
(10) Pub. No.: US 2006/0266105 A1
(43) Pub. Date: Nov. 30, 2006

(54) Wheel balancer system with automatic wheel clamping and wheel centering

(75) Inventor: Michael T. Stieff, Wentzville, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: Hunter Engineering Company

(21) Appl. No.: 11/433,936

(22) Filed: May 15, 2006

Related U.S. Application Data
(60) Provisional application No. 60/681,370, filed on May 16, 2005.

(51) Int. Cl. G01M 17/02

(52) U.S. Cl. 73/146

(57) ABSTRACT

A vehicle wheel balancer system with a controlled centering chuck for automatically centering a wheel assembly about a balancer spindle shaft, and a powered clamping device configured to provide a first clamping action which facilitates centering of the wheel assembly on the balancer spindle shaft, and a second clamping action to secure the wheel assembly on the balancer spindle shaft during rotational wheel balance measurement procedures.

### CROSS-REFERENCE TO RELATED APPLICATIONS

The present application is related to, and claims priority from, U.S. Provisional Application Ser. No. 60/681,370 filed on May 16, 2005, which is herein incorporated by reference.

### STATEMENT REGARDING FEDERALLY SPONSORED RESEARCH

Not Applicable.

### BACKGROUND OF THE INVENTION

The present invention relates generally to vehicle wheel balancer systems, and in particular, to a method and apparatus for the automatic centering and clamping of a vehicle wheel assembly onto a spindle shaft of a vehicle wheel balancer system.

Wheel balancers, such as shown in FIG. 1, have traditionally relied upon manual or assisted operation of a threaded spindle shaft and companion wing-nut to clamp a vehicle wheel assembly in place on the balancer spindle shaft during a wheel balancing operation. Alternatively, devices that slide along the spindle shaft and are powered either by a pneumatic cylinder or a motor driven screw may be used to provide a clamping force to secure the vehicle wheel assembly onto the spindle.

To center the vehicle wheel assembly on the balancer spindle shaft, devices such as centering cones are adapted to seat within an axial bore of the wheel rim of the vehicle wheel assembly, and flange plates are adapted to engage the wheel rim mounting holes of the vehicle wheel assembly. Manually operated expanding chucks may additionally be used to center the vehicle wheel assembly relative to the balancer spindle shaft.

Manually centering and clamping a vehicle wheel assembly onto a balancer spindle shaft, such as by threading a wing-nut over the balancer spindle shaft to clamp the vehicle wheel assembly against a centering cone or flange plate, is a time consuming operation which requires the operator first ensure that a properly sized centering cone or flange plate has been placed on the balancer spindle shaft, or that the centering chuck has been properly adjusted to engage the wheel rim center bore surfaces. The vehicle wheel assembly is then placed on the spindle shaft, slid into engagement with the centering component, and the threaded wing-nut tighten down the balancer spindle shaft into engagement with the vehicle wheel assembly. Some vehicle wheel balancers provide the operator with a controlled slow-speed rotation of the balancer spindle shaft to assist in the threading operation.

Alternative vehicle wheel balancer designs which automate the vehicle wheel assembly clamping process provide a mechanism for engaging a clamp assembly and moving it into engagement with the vehicle wheel assembly disposed on the balancer spindle shaft. These prior art systems provide a single clamping force for both engaging the wheel assembly and for clamping the vehicle wheel assembly, which precludes adjusting the centering position of the vehicle wheel assembly about the balancer spindle shaft after engagement with the clamp assembly. The amount of the clamping force or pressure which is necessary to secure the vehicle wheel assembly to the balancer spindle shaft is dangerous to an operator, and may present a pinch hazard for fingers or hands.

Accordingly, it would be advantageous to provide a vehicle wheel balancer system with features such as an automatic wheel centering system or an automatic wheel clamping system to assist an operator and to reduce the time required to set up each vehicle wheel for imbalance measurements. It would be further advantageous for an automatic wheel clamping system to provide two or more wheel clamping actions, such as a first action at a low pressure or force which enables a safe centering of the vehicle wheel assembly about the balancer spindle, and a second action, at a higher pressure or force which holds the vehicle wheel assembly in a secure position for balance measurements after the operator is clear of the assembly.

### BRIEF SUMMARY OF THE INVENTION

Briefly stated, the present invention provides a vehicle wheel balancer system with an expanding centering chuck and a pneumatically powered clamping device capable of providing a first clamping force to facilitate the positioning of a vehicle wheel assembly on the balancer spindle shaft, and a second clamping force to securely clamp the vehicle wheel assembly on the balancer spindle shaft after it is properly positioned.

In an alternate embodiment, the present invention provides a vehicle wheel balancer system with an actuated expanding centering chuck to facilitate centering a vehicle wheel assembly about the balance spindle shaft, and a method for operation thereof.

In an alternate embodiment, the present invention provides a vehicle wheel balancer system with a pneumatically operated multi-stage automatic clamping device for positioning and securing a vehicle wheel assembly onto a balancer spindle shaft.

The clamping device is configured to provide a first level of clamping force which is sufficient to enable an operator to position the vehicle wheel assembly on the balancer spindle shaft, and a second clamping force which is sufficient to securely clamp the vehicle wheel assembly on the balancer spindle shaft after proper positioning is ensured.

In an alternate embodiment, the present invention provides a vehicle wheel balancer system with an cup/hub keyed to the balancer spindle shaft for clamping a vehicle wheel assembly onto the balancer spindle shaft.

A method of the present invention provides a vehicle wheel balancer system with a method for automatically centering a vehicle wheel assembly about the balancer spindle shaft, and a method for providing a first clamping action to facilitate positioning of the vehicle wheel assembly on the balancer spindle shaft, and a second clamping action to facilitate securing the vehicle wheel assembly onto the balancer spindle shaft during a balancing operation.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a perspective illustration of a prior art vehicle wheel balancer;

FIG. 2A is a sectional view of the balancer-side portion of a balancer spindle shaft, illustrating the pneumatic pistons, drive-belt pulleys, and bearing assemblies;

FIG. 2B is a sectional view of the spindle-side portion of a balancer spindle shaft of FIG. 2A, illustrating the automatic centering chuck, clamping plate, and clamping pawl in engagement with the concentric clamping sleeve;

FIG. 3 is a sectional view of the automatic centering chuck, taken along line 3-3 of FIG. 2B;

FIG. 4 is a perspective view of the balancer spindle shaft end and automatic centering chuck;

FIG. 5 is a top view of the balancer spindle shaft end with the sliding sleeve in an extended position;

FIG. 6 is a top view of the balancer spindle shaft end with the sliding sleeve in a partially retracted position;

FIG. 7 is a side view of the balancer spindle shaft end with the clamping plate and clamping pawl disposed therein in a disengaged position;

FIG. 8 is a side view of the balancer spindle shaft end with the clamping plate and clamping pawl disposed therein engaged with the sliding sleeve; and

FIG. 9 is a top view of the balancer spindle shaft end with the clamping plate and clamping pawl disposed therein engaged with the sliding sleeve.

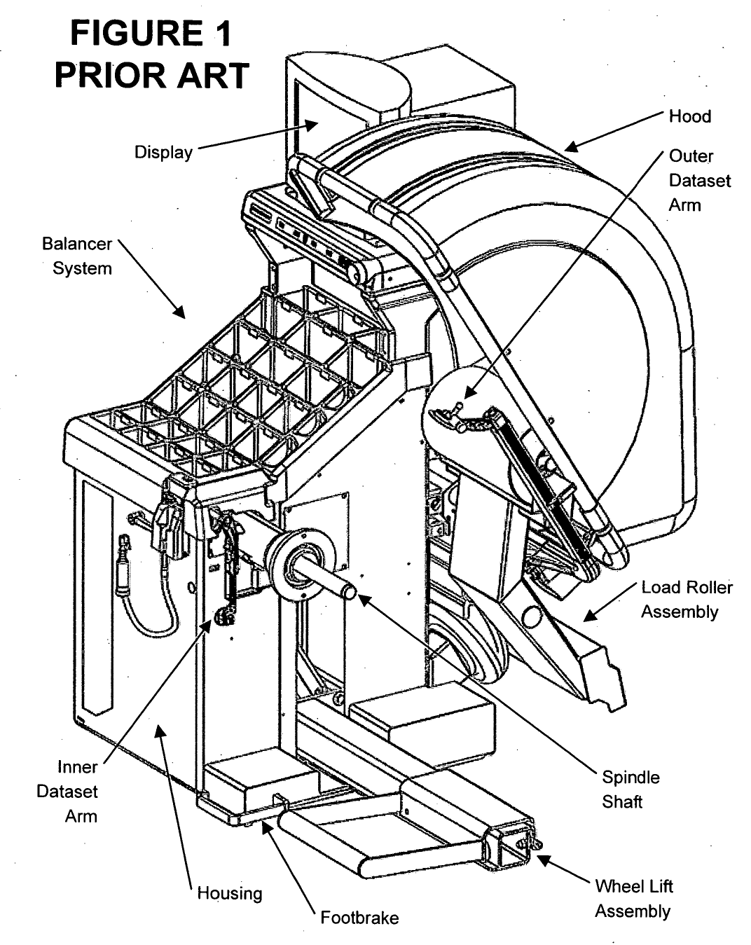

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

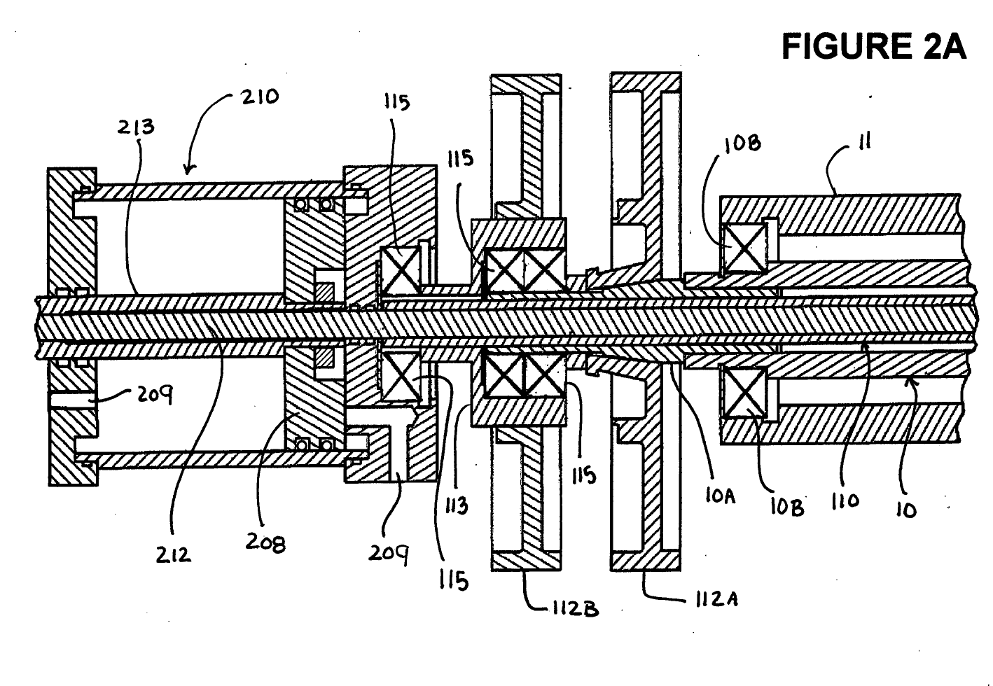

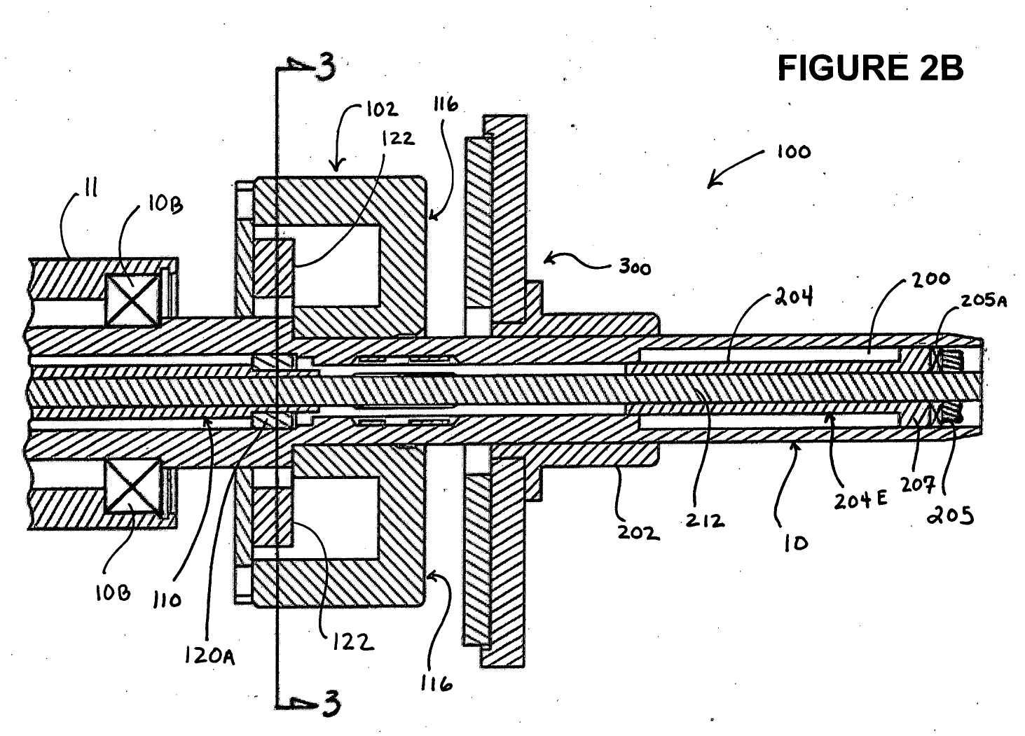

Turning to FIGS. 2A and 2B, a centering mechanism 100 and clamping mechanism 200 of the present invention are shown in one embodiment combined for use with a vehicle wheel balancer system 1 having a rotationally driven balancer spindle shaft 10 which is supported by bearings 10B in a bearing housing 11. The centering mechanism 100 consists of an electrically actuated expanding chuck 102, and operates independently from, but in conjunction with, the clamping mechanism 200 having a pneumatically-powered clamping device 202, to position and clamp a wheel assembly (not shown) onto a balancer spindle shaft 10. The expanding chuck 102 functions much as a three jaw chuck on a machine lathe, and is similar in design and operation to the manually actuated balancer centering chuck shown in U.S. Pat. No. 6,481,281 to Gerdes, herein incorporated by reference.

The expanding chuck 102 is disposed on the balancer spindle shaft 10, and is operatively coupled to a chuck drive shaft 110 which is coaxially disposed within the balancer spindle shaft 10. The chuck drive shaft 110 is, in turn coupled to a centering chuck drive pulley 112B by a coupling member 113. The coupling member 113 and the centering chuck drive pulley 112B are disposed within the housing of the vehicle wheel balancer system, and are rotationally driven by a reversible drive motor and pulley assembly (not shown), under control of a balancer processing or control system. Preferably, operation of the centering chuck drive pulley 112B is independent of operation of a spindle shaft drive pulley 112A, which is controlled to rotationally drive the balancer spindle shaft 10 which is coupled thereto by spindle extension 10A. As shown in FIG. 2A, the centering chuck drive pulley 112B may be supported and rotationally isolated from rotational movement of the spindle shaft drive pulley and associated components by bearings 115.

The expanding chuck 102 preferably includes a set of chuck jaws or teeth 114 extending longitudinally along the balancer spindle shaft 10 from a chuck face 116. The chuck jaws or teeth 114 are configured for synchronized radial movement over the chuck face 116, relative to a longitudinal axis of the balancer spindle shaft 10, in response to rotational movement of the chuck drive shaft 110 in a first direction. Reversed rotational movement of the chuck drive shaft 110 drives the chuck jaws or teeth 114 radially inward in synchronized movement, enabling the chuck jaws or teeth 114 of the centering chuck 102 to engage and release an inner surface of a wheel assembly centering hole (not shown) in a symmetric manner, thereby centering the wheel assembly about the longitudinal axis of the balancer spindle shaft 10.

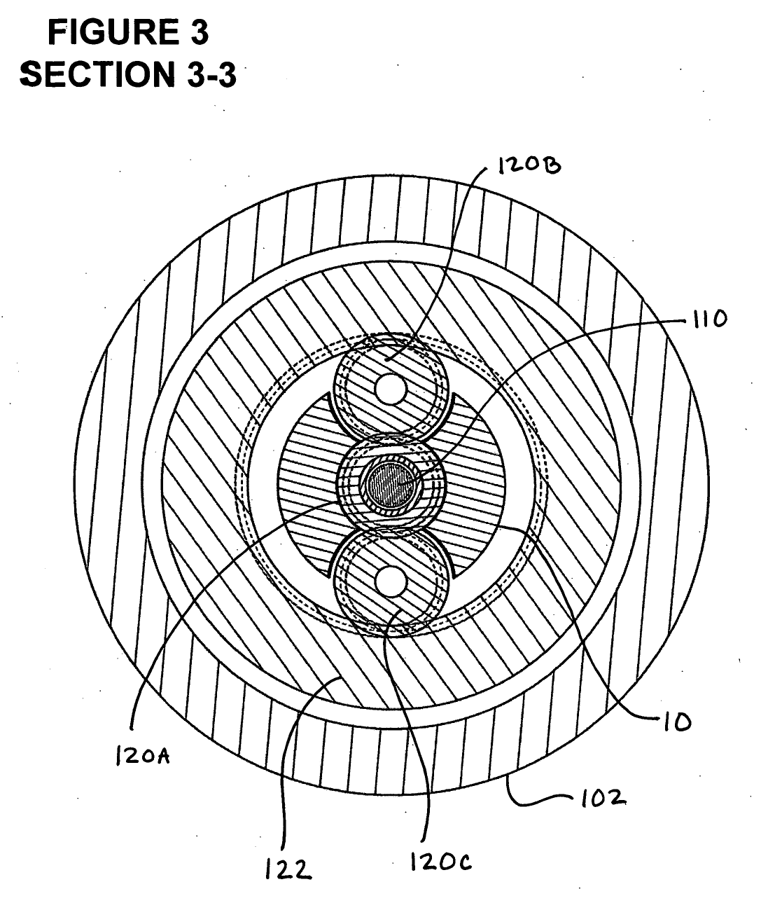

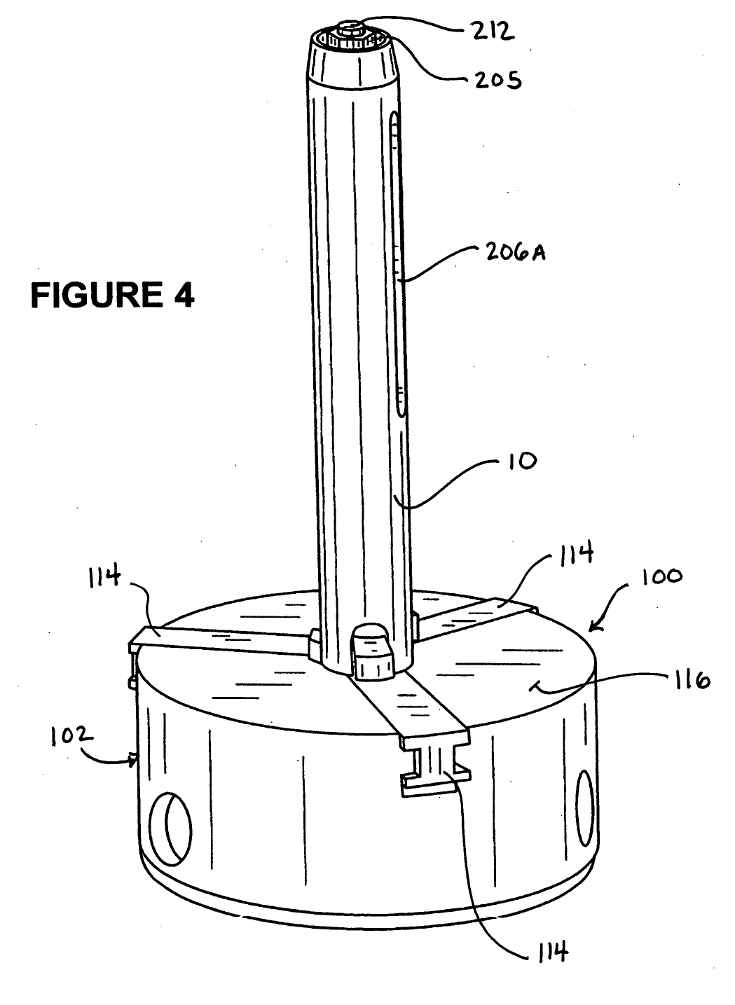

Those of ordinary skill in the art will recognize that the expanding chuck 102 may be actuated by a variety of suitable mechanisms, provided that the operation of the expanding chuck 102 is independent of the rotational movement of the balancer spindle shaft 10. For example, as is shown in FIG. 2B, FIG. 3, and FIG. 4, the expanding chuck 102 may be operatively coupled to the chuck drive shaft 110 by a set of spur gears 120A-120C. Rotational movement of the spur gears 120 in response to rotation of the chuck drive shaft 110 drives an internal ring gear 122, which in turn rotationally drives a scroll assembly (not shown) operatively coupled to the chuck jaws or teeth 114. Rotational movement of the scroll assembly in a first direction expands the chuck jaws or teeth 114, which rotational movement of the scroll assembly in a second direction retracts the chuck jaws or teeth.

Once a wheel assembly is disposed on the balancer shaft 10, the pneumatically-powered clamping device 202 which is configured to function independently from the expanding chuck 102, is used to position and clamp a wheel assembly about the balancer spindle shaft 10 and against the chuck face 116. In general, the clamping mechanism consists of a clamping member such as a cup or hub 300 which is positioned on the balancer spindle shaft 10, and engaged with an actuating mechanism to draw the clamping member 300 into engagement with a wheel assembly. The engaged wheel assembly and clamping member 300 are urged towards, and maintained in contact with, the centering mechanism 100.

For example, in the embodiment shown in FIGS. 2A and 2B, the clamping mechanism 200 may consist of a sliding sleeve 204 fitted concentrically within the balancer spindle shaft 10, and which is partially exposed through a pair of elongated longitudinal slots 206A, 206B adjacent the outermost end 12 of the balancer spindle shaft 10. An exposed portion 204E of the sliding sleeve 204 is configured with a driving portion 207, secured by a retaining nut 205 and thrust bearing 205A, having a diameter greater than that of the body of the sliding sleeve 204. The opposite end of the sliding sleeve 204 from the exposed portion 204E is coupled by a piston rod 212 extending coaxially within the balancer spindle shaft 10, to a piston 208 in a double-acting pneumatic cylinder 210. The double-acting pneumatic cylinder 210 is preferably disposed within the housing of the vehicle wheel balancer system. Movement of the piston 208, and coupled piston rod 212, along the longitudinal axis of the balancer spindle shaft 10, and the corresponding the movement of the sliding sleeve 204, is regulated by the balancer processing or control system by varying the forces or pressures acting on opposite sides of the piston 208 within the double-acting pneumatic cylinder 210. For pneumatic operation, as shown in FIG. 2A, at least one port 209 provides a controlled pathway between a source of compressed air and each side of the piston 208 within the double-acting pneumatic cylinder 210. Those of ordinary skill in the art will recognize that controlled movement of the piston rod 212 may be achieved by actuating mechanisms other than the double-acting pneumatic cylinder 210, for example, by hydraulic or electromagnetic mechanisms.

To clamp a wheel assembly onto the balancer spindle shaft 10, the clamping member 300 such as a cup or hub is fitted concentrically about the balancer spindle shaft 10, after the vehicle wheel assembly has been placed on the balancer spindle shaft 10. An engaging member 302, which may be integral with the cup or hub 300, having a number of pawls 304 corresponding to the number of elongated longitudinal slots 206 in the balancer spindle shaft 10 is positioned on the balancer spindle shaft 10. Each of the pawls 304 is adapted to removably seat within the elongated longitudinal slots 206, and to engage a driving portion 207 of the sliding sleeve 204. Controlled movement of the sliding sleeve 204 inward towards the vehicle wheel balancer housing applies a corresponding force to the pawls 304, driving the engaging member 302 and cup or hub 300 towards the centering mechanism 100, such as the face 116 of the expanding chuck 102, capturing the vehicle wheel assembly there between. The interaction of the pawls 304 and the longitudinal slots 206 provides the additional function of keying the clamping mechanism 300 to the balancer spindle shaft 10, such that the clamping mechanism 300 is precluded from rotating about the balancer spindle shaft 10.

Preferably the wheel mounting and clamping process is controlled by the balancer processing or control system to provide at least two distinct actions or stages. In the first action or stage, the will assembly is drawn against the centering mechanism 100 in such a manner as to facilitate the centering or positioning of the vehicle wheel assembly about the balancer spindle shaft 10 in a selected position by the actuation of the centering mechanism 100. In a second action or stage, the vehicle wheel assembly is held in the selected position by the clamping mechanism 300 during rotational movement of the balancer spindle shaft and vehicle wheel assembly, such as during an imbalance measurement procedure. The various actions or stages are reversible to enable removal of the vehicle wheel assembly from the balancer spindle shaft 10.

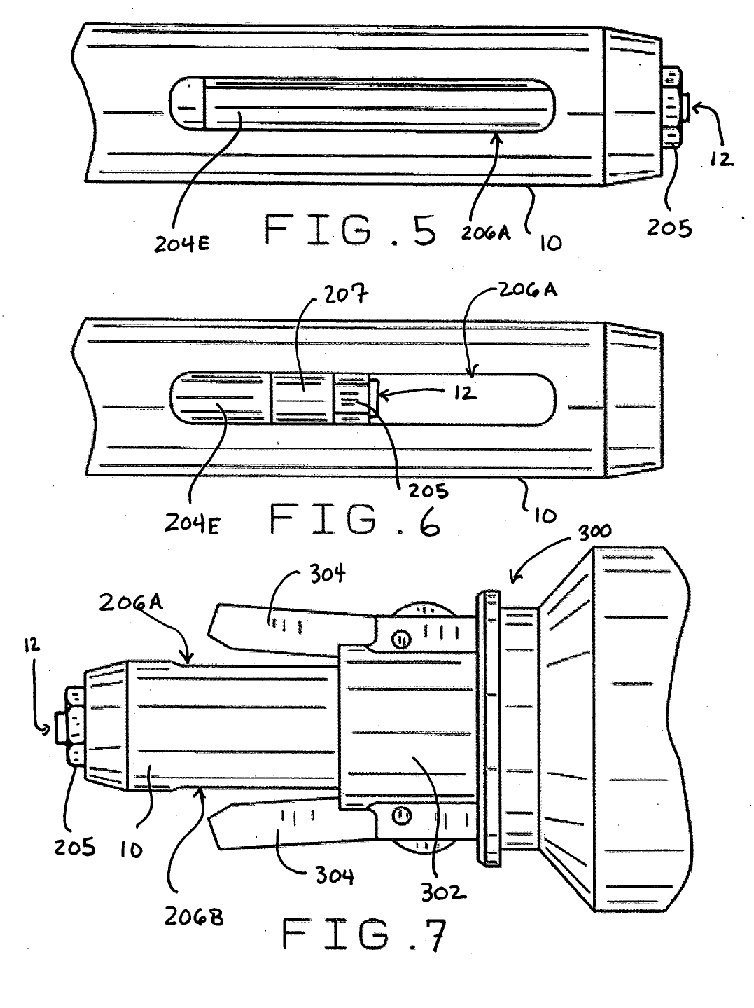

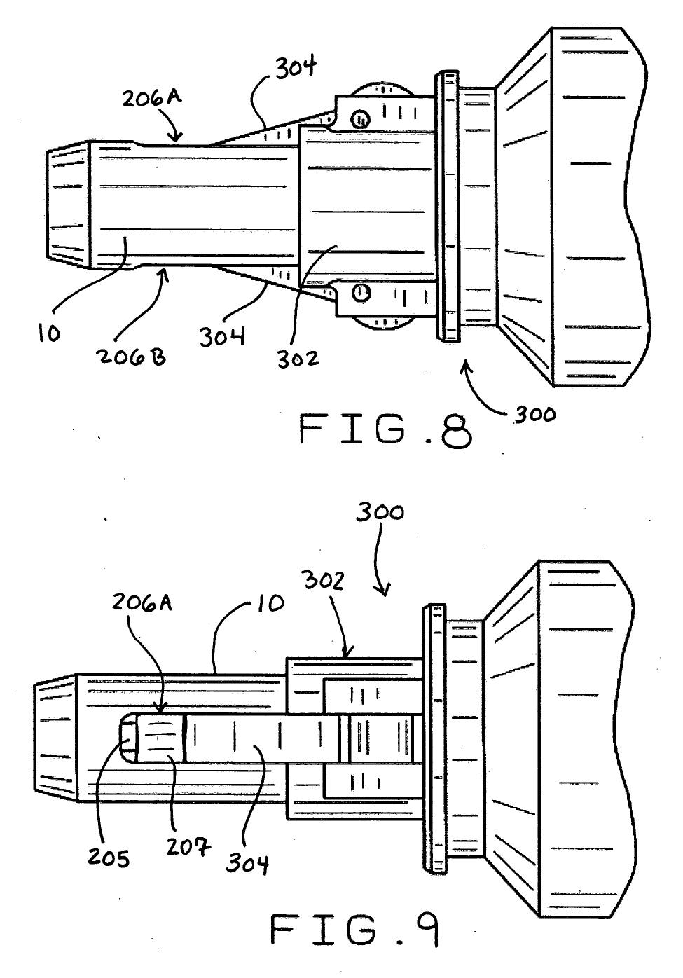

In the embodiment of the present invention illustrated in FIGS. 2A-9, movement of the sliding sleeve 204 is controlled by regulating the pressure on opposite sides of the piston 208 to provide at least two different levels of clamping force on the pawls 304 of the clamping mechanism 300. A first level of clamping force is selected for use in assisting the operating of the expanding chuck 102 by driving a wheel assembly mounted on the balancer spindle shaft 10 towards the chuck face 116. A second, and greater, level of clamping force is selected for use in holding the wheel assembly in a stable position during rotating balancing operations. The clamping forces are released by driving the sliding sleeve 204 outward, towards the outermost end 12 of the balancer spindle shaft 10, which releases the force holding the retaining element 207 against the pawls 304. The pawls 304 may then be moved out of the elongated longitudinal slots 206 to facilitate removal of the wheel assembly from the balancer spindle shaft 10.

Those of ordinary skill in the art will readily recognize that the apparatus and methods of the present invention may be carried out with centering mechanisms 100, such as expanding chucks 102, and with clamping mechanisms 300, which are actuated by different mechanisms other than those described above, without departing from the scope of the invention. For example, the centering mechanism 100 may be driven by pneumatics, or may be electrically powered. Similarly, the centering mechanism 100 may be configured in a variety of different ways. For example, the centering mechanism 100 may be configured to function in a manner similar to an expanding collet where the points that contact the wheel assembly are either uniformly deformed or pivoted to expand and center the wheel assembly about the balancer spindle shaft longitudinal axis.

Preferably, the pawls 304 of the cup or hub 300 each function to “key” the cup or hub 300 to the balancer spindle shaft 10 by the engagement of the elongated longitudinal slots 206, thereby preventing the cup or hub 300 from rotating about the balancer spindle shaft 10 during clamping. Optionally, this could also be configured in reverse, with the pawls 304 extending from the balancer spindle shaft 10 to engaging receiving feature on the clamping mechanism 300 to prevent relative rotation, or even against a surface of the wheel assembly during one of the various stages of operation

When a clamping load is applied using the cup or hub 300, friction is applied to both sides of the wheel assembly to prevent the wheel assembly from rotationally slipping around the longitudinal axis of the balancer spindle shaft 10 during a balancing procedure. In a conventional system where a cup or hub is not “keyed” to the balancer spindle shaft 10, friction is applied to only one side of the wheel assembly, and hence the resistance of the vehicle wheel assembly to rotationally slipping around the longitudinal axis of the balancer spindle shaft 10 is lower. Keying of the cup or hub 300 to the balancer spindle shaft 10 provides an improvement in slipping resistance, independent of the use of an associated clamping mechanism.

The separation of the wheel mounting and clamping procedure into two or more stages or actions, such as by the use of the double acting pneumatic cylinder 210 provides enhanced operator safety. Whenever a wheel assembly is being handled by an operator, such as during the centering procedure, a reduced or lower clamping force may be generated by applying pressure to both sides of the piston 208. The clamping loads in this condition are low enough that they pose relatively low risk of serious injury to an operator handling the vehicle wheel assembly. With proper software control and interlocks, the vehicle wheel balancer system may be configured to prevent the application of a high force clamping loads, such as during a second action or operating stage, until a hood or other safety device is closed, and the operator out of harms way.

It is intended that the vehicle wheel balancer system of the present invention be controlled by software operating instructions implemented by the balancer electronics or associated control processor. Software control optimizes the cycle time to perform all of the traditional clamping and centering functions, provides for proper sequencing of operations to ensure safe operation, and improves performance of the vehicle wheel balancer system.

One method of the present invention securely clamps a wheel assembly to the balancer spindle shaft 10 to prevent the wheel assembly from rotationally and radially slipping during balancing and road force measurement procedures. During operation, the automatic clamping and centering apparatus function as follows:

First, a wheel assembly to be measured, balanced, or matched is slid onto the unthreaded balancer spindle shaft 10 of the wheel balancer system 1, adjacent the expanding chuck 102 of the centering mechanism 100. Next, a cup or hub 300 is slid onto the balancer spindle shaft 10 and integral, spring loaded pawls 304 engage slots 206 in the balancer spindle shaft 10. The interaction between the pawls 304 and the driving element 207 of a sliding sleeve 204 within the balancer spindle shaft 10 precludes the cup or hub 300 (and therefore the wheel assembly) from backing off the outermost end 12 of the balancer spindle shaft 10. The wheel assembly is now captive on the balancer spindle shaft 10, but is not tight against the chuck face 116, and is not centered on the balancer spindle shaft 10.

With the wheel assembly positioned adjacent the expanding chuck 102, the wheel assembly is drawn into contact with the expanding chuck 102 by applying a uniform pressure across both sides of the piston 208 coupled to the piston rod 212 engaged with the clamping mechanism 300. The piston rod 212 passes through the piston 208, increasing in diameter on the opposite side of the piston 208 from the outermost end 12 of the balancer spindle shaft. When pressure is applied to the outermost side of the double acting pneumatic cylinder 210, the sliding sleeve 204 is drawn longitudinally into the balancer spindle shaft 10, and the sliding sleeve 204 engages the spring loaded pawls 304, drawing the clamping mechanism 300 along the balancer spindle shaft 10 toward the expanding chuck face 116. During the sliding movement, the clamping mechanism 300 contacts the wheel assembly and urges it along the balancer spindle shaft 10 against the expanding chuck face 116. The force with which the wheel assembly is held against the expanding chuck face 116 is limited by the pressure is applied to both sides of the piston 208. Since the piston rods 212 are of different sizes on opposing sides of the piston 208, the effective piston force is limited to the difference between the cross sectional areas of each of the piston rods 212, multiplied by the pressure applied on the piston 208.

With the wheel assembly in positioned against the expanding chuck face 116, the centering chuck 102 is actuated to center the wheel assembly about the axis of the balancer spindle shaft 10. Preferably the wheel assembly is not held in place with a full clamping load, and the wheel assembly is able to slide along the face 116 of the centering chuck 102 until it is centered. Because the wheel assembly is also moving relative to the cup or hub 300, it must either slide against the cup or hub 300, or the cup or hub 300 must have some compliance to allow the wheel assembly to move to its centered position. In an embodiment of the present invention, the clamping force is regulated by a double acting pneumatic cylinder 210, enabling a reduction in the clamping force applied to the wheel assembly by bleeding off pressure from the appropriate side of the piston 208. This allows the cup or hub 300 to momentarily relax and re-center should any compliance have caused distortion. Once the cup or hub 300 has been re-centered, clamping pressure is reapplied. By performing this process repeatedly, it is possible to accommodate wheel assemblies that have large center holes that must move relatively long distances to their centered position, effectively “walking” the wheel into position without having an inordinate amount of compliance in the cup or hub 300, or sliding across the face of the wheel assembly.

Once the wheel assembly is centered by the centering mechanism 200, the clamping force exerted on the clamping mechanism 300 by the piston 208 is increased to a holding level, and the wheel assembly is ready for balance measurement procedures. In an embodiment of the present invention utilizing the double acting pneumatic cylinder 210 to regulate clamping pressure, the pressure is bled off the side of the piston 208 with the larger diameter piston rod 212B, increasing the effective clamping force on the vehicle wheel assembly.

While the wheel assembly is mounted to the balancer spindle shaft 10 it is possible to vary the clamp load in a manner similar to that already discussed. By doing this while further activating the centering chuck 102 it is possible to further ensure that the wheel assembly is well centered about the axis of the balancer spindle shaft 10.

Upon completing a spin or balance procedure, the pressure is once again applied to both sides of the double-acting piston 210 to reduce clamp force applied by the clamping mechanism 200. Simultaneously, the jaws or teeth 114 of the centering mechanism 102 are retracted, lowering the wheel assembly to the balancer spindle shaft 10 by the force of gravity overcoming the friction caused by the clamping force. In the same way that the wheel assembly slid or was “walked” into its centered position, the wheel assembly is returned to a lowered position resting on the balancer spindle shaft 10 for removal there from.

Pressure is next relieved from the side of the double-acting piston 210 with the smaller diameter piston rod 212A, allowing the smaller diameter piston rod 212A to extend within the balancer spindle shaft 10, moving the sliding sleeve 204 towards the outermost end 12 of the balancer spindle shaft 12, releasing the clamping force securing the cup or hub 300.

Finally, the spring loaded pawls 304 of the cup or hub 300 are retracted and the cup or hub 300, and subsequently the wheel assembly, are removed from the balancer spindle shaft 10.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. An improved vehicle wheel balancer system having a rotationally driven balancer spindle shaft for supporting a vehicle wheel assembly during an imbalance measurement procedure, the improvement comprising:
an adjustable centering mechanism associated with said balancer spindle shaft for centering the vehicle wheel assembly about the balancer spindle shaft.

2. The improved vehicle wheel balancer of claim 1 wherein said centering mechanism is configured for wheel assembly centering operation independent of rotation movement of the balancer spindle shaft.

3. The improved vehicle wheel balancer system of claim 1 wherein said centering mechanism is an expanding chuck having a chuck face and a plurality of jaws configured for radially symmetric movement relative to said chuck face.

4. The improved vehicle wheel balancer system of claim 1 further including a centering mechanism actuating means disposed concentric with said balancer spindle shaft.

5. The improved vehicle wheel balancer system of claim 1 wherein said centering mechanism is electrically actuated.

6. The improved vehicle wheel balancer system of claim 1 wherein said centering mechanism is pneumatically actuated.

7. The improved vehicle wheel balancer system of claim 1 further including a control system operatively coupled to an actuating mechanism associated with said adjustable centering mechanism, said control system selectively actuating said adjustable centering mechanism by controlling operation of said actuating mechanism.

8. An improved vehicle wheel balancer system having a rotationally driven balancer spindle shaft, the improvement comprising:
a clamping mechanism for securing a wheel assembly about the balancer spindle shaft, said clamping mechanism keyed in a fixed rotational position about said balancer spindle shaft.

9. An improved vehicle wheel balancer system having a rotationally driven balancer spindle shaft, the improvement comprising:
a clamping mechanism associated with the balancer spindle shaft, said clamping mechanism configured to effect a first clamping action on a wheel assembly disposed on the balancer spindle shaft associated with a mounting operation, and to effect a second clamping action on said wheel assembly associated with a balancing operation.

10. The improved vehicle wheel balancer system of claim 9 wherein said clamping mechanism is keyed in a fixed rotational position about said balancer spindle shaft.

11. The improved vehicle wheel balancer system of claim 9 wherein said first clamping action is the application of a first clamping force; and wherein said second clamping action is the application of a second clamping force.

12. The improved vehicle wheel balancer system of claim 9 further including an actuating assembly coaxial with said balancer spindle shaft, said actuating assembly configured for controlled linear movement relative to said balancer spindle shaft; and
wherein said clamping mechanism is configured to operatively engage said actuating assembly to convey said first and second clamping forces from said actuating assembly to said wheel assembly.

13. The improved vehicle wheel balancer system of claim 12 wherein said actuating assembly includes a double acting pneumatic cylinder.

14. The improved vehicle wheel balancer system of claim 12 further including a control system operatively coupled to said actuating assembly, said control system regulating linear movement of said actuating assembly.

15. An improved vehicle wheel balancer system having a rotationally driven balancer spindle shaft, the improvement comprising:
an adjustable centering mechanism for centering of a vehicle wheel assembly about said balancer spindle shaft, said adjustable centering mechanism disposed on said balancer spindle shaft; and
a clamping mechanism associated with the balancer spindle shaft, said clamping mechanism configured to perform a first clamping action on a wheel assembly disposed on the balancer spindle shaft associated with a mounting operation, and to perform a second clamping action on said wheel assembly associated with a balancing operation.

16. The improved vehicle wheel balancer system of claim 15 wherein said adjustable centering mechanism is configured for wheel assembly centering operations independent from rotational movement of said balancer spindle shaft.

17. The improved vehicle wheel balancer system of claim 15 wherein said clamping mechanism is configured for application of a first clamping force associated with said first clamping action; and wherein said clamping mechanism is configured for application of a second clamping force associated with said second clamping action, said second clamping force greater than said first clamping force.

18. The improved vehicle wheel balancer system of claim 15 further including a control system configured to control operation of said adjustable centering mechanism and said clamping mechanism.

19. A method for mounting a wheel assembly on a spindle shaft of a vehicle wheel balancer having a controlled centering mechanism and a controlled clamping mechanism, comprising;
positioning the wheel assembly about the balancer spindle shaft in operative relation to the controlled centering mechanism;
engaging the controlled clamping mechanism with the wheel assembly;
applying a first controlled clamping action to the wheel assembly with the controlled clamping mechanism to move the wheel assembly into radially-sliding engagement with said face of the controlled centering mechanism;
actuating the controlled centering mechanism to position the wheel assembly in a concentric position about the longitudinal axis the balancer spindle shaft; and
subsequently applying a second controlled clamping action to the vehicle wheel assembly with the controlled clamping mechanism to maintain the wheel assembly in a fixed engagement with the controlled centering mechanism.

20. The method of claim 19 wherein said first controlled clamping action includes applying a first clamping force to the vehicle wheel assembly;
wherein said second controlled clamping action includes applying a second clamping force to the vehicle wheel assembly; and
wherein said second controlled clamping force is greater than said first controlled clamping force.

21. The method of claim 19 wherein said step of actuating the controlled centering mechanism includes symmetrically altering a configuration of said controlled centering mechanism about the longitudinal axis of the balancer spindle shaft to engage a surface of the wheel assembly.

22. A method for securing a vehicle wheel assembly onto the spindle shaft of a vehicle wheel balancer system, comprising:
disposing the vehicle wheel assembly on the balancer spindle shaft;
centering the vehicle wheel assembly about the balancer spindle shaft; and
securing the vehicle wheel assembly in said centered configuration about the balancer spindle shaft with a clamping mechanism keyed to the balancer spindle shaft to prevent relative rotation between said clamping mechanism and said balancer spindle shaft.

23. A method for mounting a vehicle wheel assembly onto the spindle shaft of a vehicle wheel balancer system, comprising:
disposing the vehicle wheel assembly on the balancer spindle shaft;
engaging the vehicle wheel assembly with an adjustable centering mechanism;
actuating said adjustable centering mechanism to dispose the vehicle wheel assembly in a centered configuration about a longitudinal axis of the balancer spindle shaft.

24. The method of claim 23 further including the step of reversing actuation of said adjustable centering mechanism to release the vehicle wheel assembly from said centered configuration about said longitudinal axis of the balancer spindle shaft prior to removal of the vehicle wheel assembly from the balancer spindle shaft.

25. A method for mounting a vehicle wheel assembly onto the spindle shaft of a vehicle wheel balancer system, comprising:
disposing the vehicle wheel assembly on the balancer spindle shaft;
effecting a first clamping action to facilitate positioning of the vehicle wheel assembly in a selected position about the balancer spindle shaft;
positioning the vehicle wheel assembly in said selected position;
subsequent to positioning of the vehicle wheel assembly in said selected position, effecting a second clamping action to maintain the vehicle wheel assembly in said selected position during rotational movement of the vehicle wheel assembly and the balancer spindle shaft.

26. The method of claim 25 wherein said step of effecting said first clamping action includes applying a first clamping force to the vehicle wheel assembly; and
wherein said step of effecting said second clamping action includes applying a second clamping force to the vehicle wheel assembly, said second clamping force being greater than said first clamping force.

27. The method of claim 25 further including the step of disposing a clamping member on the balancer spindle shaft after disposing the vehicle wheel assembly on the balancer spindle shaft;
engaging said clamping member with an actuating mechanism associated with the balancer spindle shaft; and
wherein said steps of effecting said first and second clamping actions each include controlling said actuating mechanism to draw said clamping member along the balancer spindle shaft towards the vehicle wheel assembly.
